(19) United States
(12) Patent Application Publication
(10) Pub. No.: US 2014/0103683 A1
(43) Pub. Date: Apr. 17, 2014

(54) Deployable Vehicle Window Glass Protection System

(71) Applicant: James R. Giddens, North Street, MI (US)

(72) Inventor: James R. Giddens, North Street, MI (US)

(21) Appl. No.: 14/020,959

(22) Filed: Sep. 9, 2013

Related U.S. Application Data
(60) Provisional application No. 61/714,533, filed on Oct. 16, 2012.

(51) Int. Cl. B60J 1/20

(52) U.S. Cl. CPC B60J 1/2094
USPC 296/152

(57) ABSTRACT

A deployable vehicle window shield system is provided comprising an outer protective surface that is deployable over a transparent vehicle window and retained within the vehicle door. The system comprises a first and second window regulator, the first for the transparent vehicle glass and the second for the outer protective surface. The vehicle door comprises a first and second window track for supporting the glass interiorly with respect to the outer protective surface. The window regulator for the outer protective surface is controlled by the user via in-vehicle controls or by remote, wherein the regulator is functional only when the vehicle engine is stopped or the vehicle is in park, while the protective surfaces retract when the vehicle starts. This prevents activation of an opaque surface over the vehicle glass while the vehicle is in operation.

### CROSS REFERENCE TO RELATED APPLICATION

This application claims the benefit of U.S. Provisional Application No. 61/714,533 filed on Oct. 16, 2012, entitled “Metal Shell Cover.” The above identified patent application is herein incorporated by reference in its entirety to provide continuity of disclosure.

### BACKGROUND OF THE INVENTION

1. Field of the Invention

The present invention relates to vehicle protection devices and to vehicle windows. More specifically, the present invention pertains to a retractable and deployable protective surface disposed along a track outside of the normal vehicle side window, wherein the device can shroud the window to prevent easy break-ins or peaking therethrough.

Vehicle break-ins are an all too common problem for many vehicle owners, including those in metropolitan areas and for those in suburban areas. A vehicle left unmonitored for long periods of time makes for an easy target for a would-be thief, particularly if the vehicle is placed in a secluded location or parked outside overnight. Vehicle break-ins range in severity and expense for the vehicle owner, as the vehicle can easily be subjected to vandalism or even complete theft, while at the same time any of the owner's personal property maintains within the car is at risk of being taken with a simple breakage of the door window glass. At a minimum, vehicle break-ins result in wasted time and expense for the owner when the owner is required to address a shattered window or entire vehicle theft.

Combatting this vehicle break-in plague is a difficult task, requiring vigilance from both owners and from law enforcement. Many precincts employ video cameras, deploy neighborhood watch individuals, or increase police presence through the day and night time hours. However, these measures do little to eliminate the temptation of thieves and are subordinate to measures that vehicle owners can take to prepare their vehicle when parking outside or in unknown areas.

Many owners do not properly remove personal items from within the vehicle, including luggage items, electronic devices, and even actual money from therein. This makes for an easy smash-and-grab scenario for a thief, as the items are easily spotted in the vehicle and the thief does not have to rummage around or guess what is inside the vehicle. Properly addressing the interior space of a vehicle left unaccompanied for periods of time is imperative to preventing break-ins and lowering the percentage of such events for one's specific vehicle.

Along with cleaning out the visually-identifiable contents from within the vehicle cabin, owners can also arm their vehicles with alarm systems and take measures to reduce the clarity through the windows using vehicle tinting. Alarm systems are effective for preventing complete vehicle theft, but are not always conspicuous enough to notify a would-be thief that the alarm is installed and will activate in the event of window breakage. Therefore, this option does not save an owner from glass breakage prior to the alarm sounding and the criminal escaping the scene. Reducing visual clarity through the window is another option that can reduce peering inside the vehicle, but window tinting only goes so far and is not legal to install in all states.

What is required therefore is a means of safeguarding a vehicle, wherein the side window glass is shrouded from view and protected from easy shattering from a thief's tools when parked. The present invention discloses a vehicle side window protection system that employs protective window shrouds that are operably positioned over the window glass from the exterior side thereof when the vehicle is parked and left unaccompanied. The system is designed to operate when the vehicle is off and eliminate visibility through the window glass, while also preventing access to the window glass itself in order to prevent easy shattering thereof. The shrouds are positioned within a separate track along the vehicle doors and can be operated by remote or from within the vehicle, whereby the user parks his or her vehicle and deploys the shrouds to limit unauthorized access through the side windows and to discourage break-ins from occurring.

2. Description of the Prior Art

Devices have been disclosed in the prior art that relate to window protection devices and vehicle protective glass. These devices generally relate to militarized vehicle systems and means of armoring a vehicle. The following is a list of devices deemed most relevant to the present disclosure, which are herein described for the purposes of highlighting and differentiating the unique aspects of the present invention, and further highlighting the drawbacks existing in the prior art.

One such device in the prior art is U.S. Pat. No. 4,331,359 to Sheldon, which discloses a window shield that is positioned outside and adjacent to the vehicle glass along the side of the vehicle. The shield operates by electric motor for vertical movement via a switch within the vehicle. Similar to the automotive glass, the shield enters into a gasket to seat the edges thereof when in a closed position. The Sheldon device describes a very similar device, but fails to disclose the safety features and improvements to vehicle window shields disclosed herein.

Similar to the Sheldon device, U.S. Pat. No. 6,604,776 to Edwards discloses a vehicle theft prevention system that includes extendable and retractable cover plates over the windows of the vehicle, as well as covers for the keyhole locks. The system can utilize the motors of the window assembly or utilize independent motors, while cover plates are provided over all exposed window surfaces. As with the Sheldon device, the Edwards device fails to contemplate the safety mechanisms and remote operating functions that add safety and convenience to the system.

Another such device is U.S. Pat. No. 3,923,339 to McDonald, which discloses a quickly attachable transparent window armor that protects the occupants and interior articles from unauthorized persons. The armor is bullet resistant and transparent, while the connection to the vehicle includes a plurality of fabric straps and clip elements for securing the panel to the window trim. While providing a means of protection for items in the vehicle, the McDonald device is directed to an armor solution for a vehicle, as opposed to an opaque shield for preventing unauthorized peering or window breaking from criminals when the vehicle is unoccupied.

The present invention discloses a new and novel vehicle glass protection system that offers an exterior shroud that is deployable along the outer portion of the window glass and from within the vehicle door. The shroud rides along a separate window track and is operated by a separate window regulator than that of the window glass, wherein the shroud regulator is operable when the user parks the vehicle or ceases operation of the vehicle engine. The goal is to provide a protective system operable when the car is parked and left unaccompanied for periods of time, wherein the shrouds may be opaque to eliminate peering therethrough and comprised of a resistant material that is not easily broken or bypassed.

It is submitted that the present invention is substantially divergent in design elements from the prior art, and consequently it is clear that there is a need in the art for an improvement to existing vehicle window glass protection systems. In this regard the instant invention substantially fulfills these needs.

### SUMMARY OF THE INVENTION

In view of the foregoing disadvantages inherent in the known types of window protection systems now present in the prior art, the present invention provides a new vehicle glass protection system that can be utilized for providing convenience for the user when shrouding and protecting the side window glass of a vehicle when the car is parked and unaccompanied.

It is therefore an object of the present invention to provide a new and improved vehicle window glass protection system that has all of the advantages of the prior art and none of the disadvantages.

It is another object of the present invention to provide a deployable vehicle window glass protection system that comprises a vehicle door having a first and second window track and a first and second window regulator, the first regulator and track for the window glass and the second regulator and track for an exterior shroud that is adapted to conceal the window glass surface from exterior access.

Another object of the present invention is to provide a deployable vehicle window glass protection system that includes an electrical setup that does not allow regulator operation of the exterior shroud until the vehicle is stopped or parked, and one that automatically lowers the shroud if the vehicle is started or moved out of a parked state.

Yet another object of the present invention is to provide a deployable vehicle window glass protection system that offers an opaque and puncture resistant shroud to protecting the vehicle window glass from contact with window breaking tools and from peering therethrough.

Another object of the present invention is to provide a deployable vehicle window glass protection system may be readily deployed using components and a vehicle door design that permit relative economy and are commensurate with durability and quality standards of the vehicle.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an internal view of a vehicle door with the present system installed therein.

FIG. 2 shows an overhead view of the first and second window tracks of the vehicle door of the present invention.

FIG. 3 shows a view of the vehicle door of the present invention, wherein the window shroud is being deployed.

FIG. 4 shows a flow diagram of the operation of the present system.

FIG. 5 shows a flow diagram of the operation of the present system.

FIG. 6 shows a flow diagram of the operation of the present system.

### DETAILED DESCRIPTION OF THE INVENTION

Reference is made herein to the attached drawings. Like reference numerals are used throughout the drawings to depict like or similar elements of the vehicle window glass protection system. For the purposes of presenting a brief and clear description of the present invention, the preferred embodiment will be discussed as used for shrouding a vehicle window glass to prevent damage thereto or peering therethrough. The figures are intended for representative purposes only and should not be considered to be limiting in any respect.

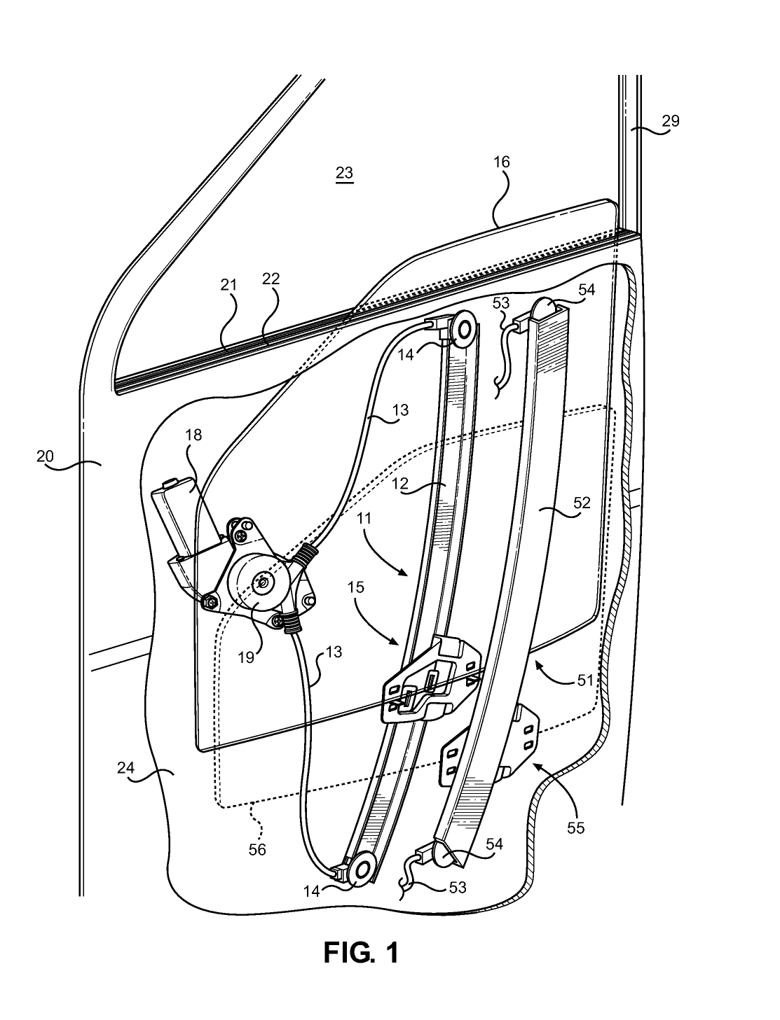

Referring now to FIG. 1, there is shown a cut-away view of a vehicle door 20 fitted with the window protection system of the present invention. The vehicle door 20 includes an open interior 24, an outer surface that forms the exterior of the vehicle, an interior surface covered by interior body paneling, and an upper window frame 29. Within the window frame 29 is an open interior section 23 adapted to be covered by a first vehicle window glass 16 and a second protective shroud 56.

The door window glass 16 is mounted interiorly with respect to the shroud 56, and each have their own track 21, 22, respectively. The window track 21 guides the window glass 16 from within the door and into a closed position, wherein the glass 21 fills the open interior section 23 of the window frame 23. The shroud track 22 is mounted in parallel to the window track 21 and is positioned outward from the window track 21, whereby the shroud 56 will cover the exterior surface of the window glass 16 when fully deployed within the interior section 23 of the door window frame 29.

The vehicle door 20 of the present invention is configured as would normally be provided on a passenger vehicle, however greater room is afforded within the door for the internal window and shroud operational components. A first window regulator 11 supports and controls the operation of the window glass 16, while a second window regulator 58 (see FIG. 6) is adapted to be mounted in a mirrored configuration with respect to the first regulator 11 and supports the outer protective shroud 56. Each regulator preferably comprises a first rail 12, 52, a movable window support hub 15, 55, and a separate regulator motor 18. It is contemplated that different designs for the regulator may be utilized in conjunction with the present system, including a pair of scissor mechanisms, cable mechanisms, or the like. The preferred embodiment is a cable-driven regulator assembly that utilizes a spool 19 of cable routed through a guide tube 13, 53 to pulleys 14, 54 mounted on the ends of the rails 12, 52 and connected to the movable support hubs 15, 55. When operated, the regulator motor 18 winds the spool 19, which moves the hub upwards or downwards along a respective rail.

In the preferred embodiment, the door interior 24 supports the two regulator motors and regulator rails 12, 52 in a position that places the window glass 16 along the interior track 21 of the door and the protective shroud 56 along the exterior track 22 of the door. When the window 16 and shroud 56 and elevated into a closed position, the window frame open interior perimeter includes a window and shroud seal therearound to affect a secure fitment of the two items in the open interior 23 of the window frame. This prevents air from passing over the edges of the window glass 16 and protective shroud 56 when deployed and in a closed position. This further allows the shroud 56 to be fully deployed over the window glass 16 to prevent access thereto from the exterior of the car when the door is closed.

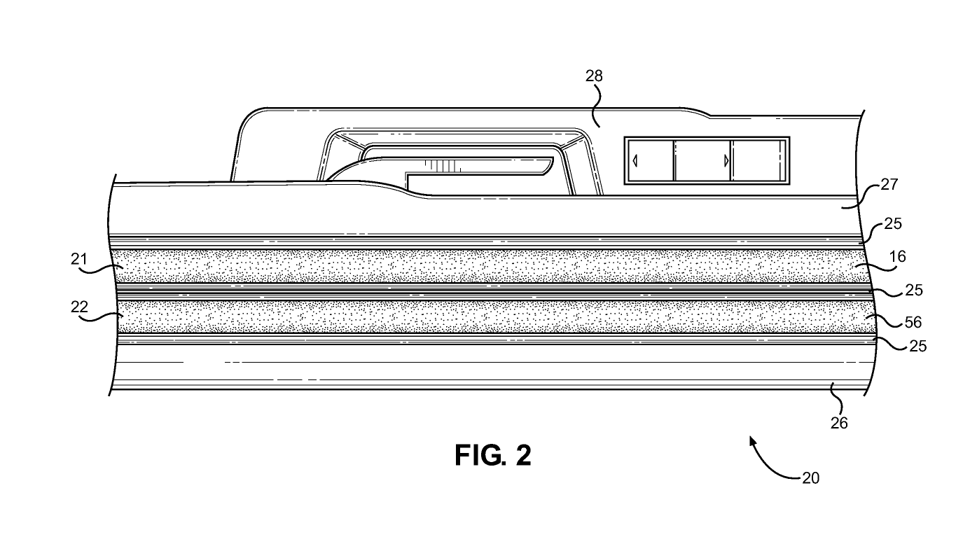

Referring now to FIG. 2, there is shown an overhead view of the vehicle door 20 of the present invention with the protective shroud 56 and the window glass 16 in a lowered position. In this view, the relative positioning of the shroud track 22 and the window glass track 21 is readily visible, wherein the shroud 56 is mounted through the door 20 exteriorly with respect to the window glass 16 such that the shroud 56 can protect the glass 16 when deployed. Along both sides of the shroud track 22 and window glass track 21 at the opening along the base of the door window frame interior is a first and second sealing element 25. This sealing element 25 is a well-known means of sealing the interior of the door 20 from water and debris when the window 16 and shroud 56 are in a deployed state. The sealing elements 25 cover the gap between the track opening and the shroud/window. This arrangement is well understood in the art of automotive window design.

To accommodate the two tracks 21, 22, the thickness of the regulators, and the shroud and window themselves, the door exterior 26 or interior 27 surface may be required to be bumped out to make room within the door interior for all of the system components. It is contemplated that the present system requires a specifically designed door, including the design of the door itself, its interior structure, the separate tracks, and the door window frame design.

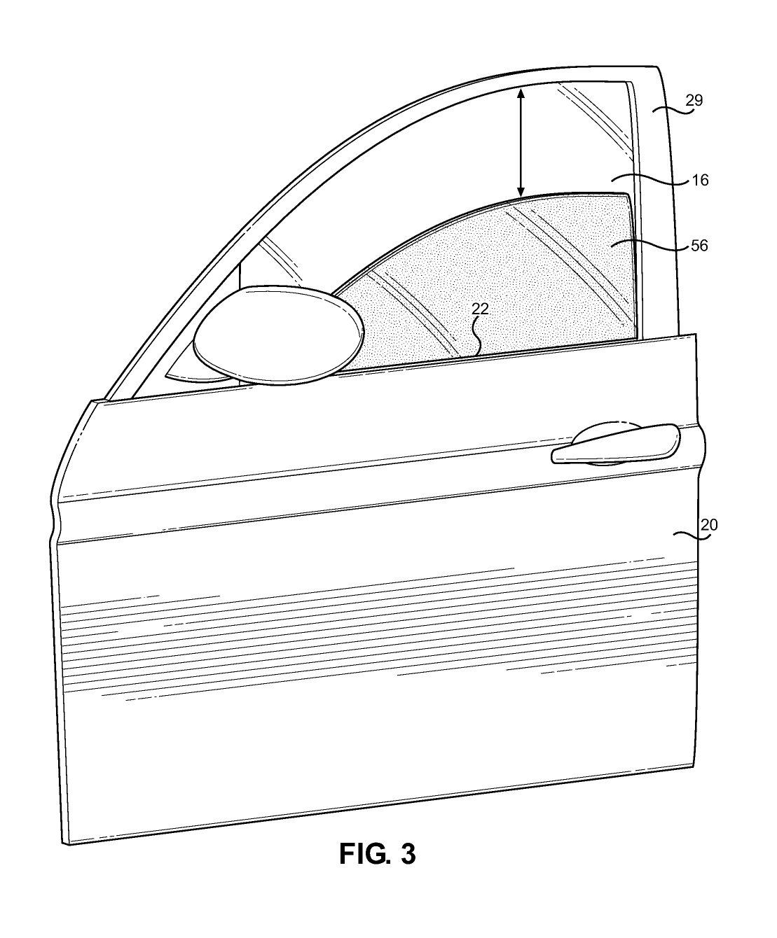

Referring now to FIG. 3, there is shown a view of the shroud 56 of the present invention being deployed from within the vehicle door 20 into a working state over the outer surface of the vehicle glass 16. When deployed, the shroud 56 extends from its track 22 along the base of the window frame 29 and enters a track that runs along the entire perimeter of the window frame 29, similar to that provided for the window glass 16 when in a fully deployed state.

The present invention is driven preferably by an electric motor and switch, which draws power from the vehicle battery. The switch is operational when the vehicle is in park or the vehicle engine is not operational. This ensures the shrouds 56 of the vehicle will not deploy and cover the driver's view through the window glass 16 when the vehicle is in motion. Furthermore, the regulators operate and lower the window shrouds 56 if the vehicle is started or moved into a “drive” state. This automatic operation eliminates the need for a user to manually retract the shrouds prior to driving, and ensures they are not deployed when the vehicle is being driven.

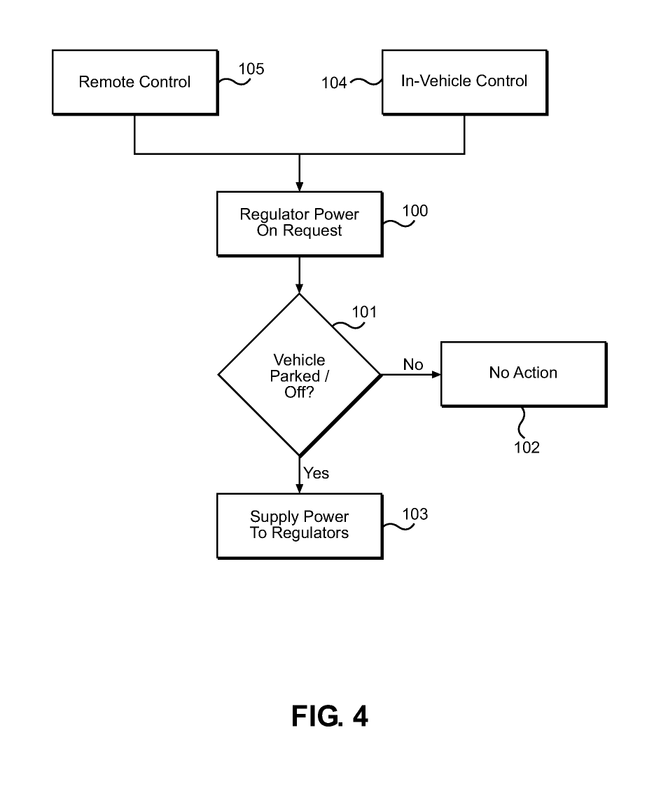

Referring now to FIG. 4, there is shown a flow diagram of the present invention and the logic utilized to determine if power is provided to the shroud regulators for operation thereof. First, a request 100 is made by the operator to deploy the shrouds, via remote control 105 or by in-vehicle switches 104. If the vehicle is in “drive”, or if the vehicle is operational for a manually driven car 101, then no action 102 is taken. If the vehicle is in “park” or the engine is off 101, power from the vehicle battery is delivered to the regulators 103 to deploy the same. Conversely, if the vehicle is moved into a state of “drive” or the engine is started (in the case of a vehicle with a manual transmission), the regulators are all operated to lower the shrouds to a stowed state within the vehicle doors. The position of the shrouds is maintained by a circuit within the regulators, which determines when the shrouds are deployed, stowed, and when the cease movement of the regulator hubs after a given time.

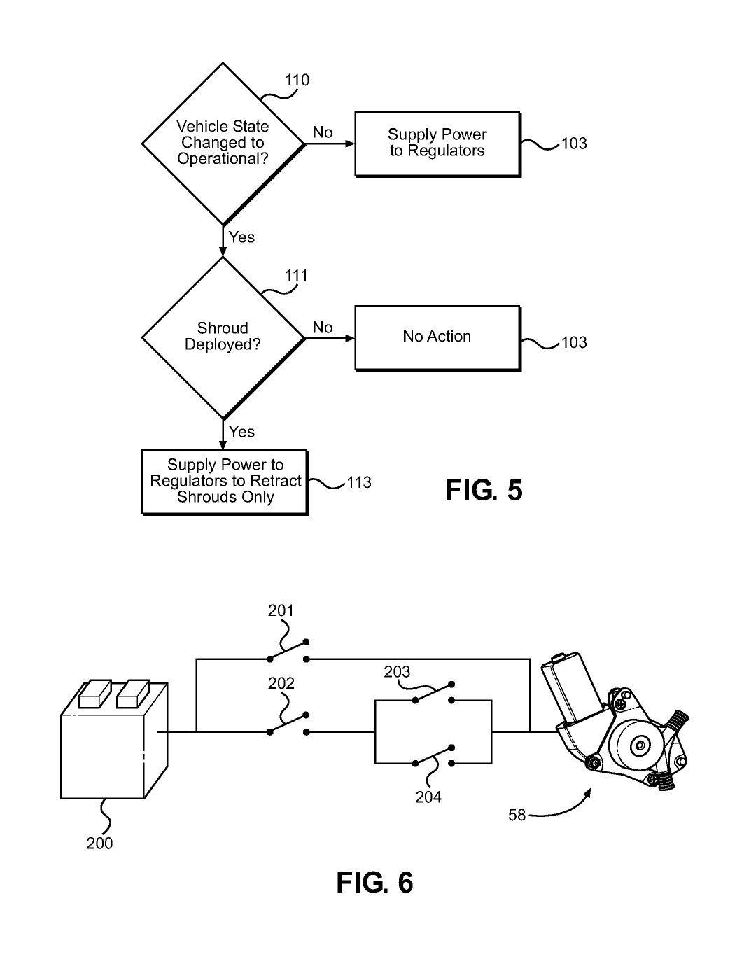

The operation of the shroud regulator is contemplated as the very same as the window glass regulator, with the exception of power delivery to the regulator motor when the vehicle is operational. Referring to FIG. 5, the present system is adapted to lower the shrouds if the vehicle is started or moved from a parked state, and further adapted to supply power to the shroud regulators for deploying the same only when the vehicle is parked or in a non-operational state. When the vehicle is in a parked state (engine off or transmission in “park”), and the user starts the car or moves from a “park” state 110, the present system will check to ensure the shrouds are not deployed 111. If the shrouds are not deployed when the vehicle is moved from a non-operational state to an operational state 110, no action is required 112. However, if the shrouds are deployed during this change, a relay will send power from the vehicle battery to the shroud regulators (second window regulators) 113 for retracting the same. Power is sent thereto and the regulators are directed to operation to retract the shrouds only. If the vehicle remains in a non-operational state, the user can simply deploy or retract the shrouds at his or her command 103 via the in-car switch or via external remote control.

Referring now to FIG. 6, it is contemplated that the in-vehicle switch for the user is a 203 manual electrical switch, which connects the second window regulator 58 (shroud regulator) to the vehicle battery power 200 when the vehicle is in a non-operational state (in “park” or when engine is off). A remote can be utilized to connect the second window regulators 58 to the vehicle power, wherein the remote control operates a relay 204 in the vehicle when the vehicle is in the same non-operational state. This allows the user to raise and lower the shrouds without being in the car when the car is parked. Finally, a master relay 202 controls the connection of the in-vehicle switch 203 and remote controlled relay 204 to the battery 200, wherein the master relay 202 ceases electrical connection between the vehicle battery 200 and the second window regulators 58 when the vehicle is operation (in “drive” or when the engine is on). Finally, a second relay 201 in parallel with the in-vehicle switch 203 and remote-controlled relay 204 is utilized to automatically lower the shrouds when the vehicle state changes from non-operational to operational while the shrouds are deployed. If this occurs, the second relay 201 supplies vehicle power to the second window regulators 58 for downward movement thereof, whereby the shrouds are retracted into the window interior prior to the car departing.

The present invention describes a window shroud system for a passenger vehicle. The shroud of the present invention is contemplated as a hard plastic, metal, or similar protective material that will not shatter or easily break when impacted. The system can be operated by in-vehicle control switches or via an external, handheld remote control. When a user parks his or her car, the shrouds can be extended, which prevents theft of the vehicle, peering thereinto, and eliminates shattered window glass from a break-in event. The system further includes a safety mechanism that will allow the cover to engage only when the vehicle is turned off or in a parked state. The present invention slows down and stops people from breaking into vehicles through their windows, deters people from trying to break into a vehicle, and blends in with the rest of the vehicle while in use if the shrouds are designed to coordinate with the vehicle body paneling.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A deployable vehicle window glass protection system for a vehicle, comprising:
a vehicle door having an outer surface, an inner surface, an interior volume therebetween, and a window frame;
said window frame having an open interior, a base, and perimeter interior edges forming the sides and upper of the window frame;
a first and second window track along the base of said window frame, said first window track mounted interiorly with respect to said second window track along said window frame base;
a window glass mounted within said first window track and adapted to secure within said window frame perimeter edges when in a deployed state, and retract into said vehicle door interior volume when in a retracted state;
a first window regulator for moveably supporting said first window glass between said deployed state and said retracted state;
a window glass shroud mounted within said second window track and adapted to secure within said window frame perimeter edges when in a deployed state, and retract into said vehicle door interior volume when in a retracted state;
a second window regulator for moveably supporting said window glass shroud between said deployed state and said retracted state;
an electrical switch electrically connected to between said second window regulator and vehicle power for operably supplying vehicle power thereto when said vehicle is in a non-operational state;
said vehicle power being disconnected from said second window regulator when said vehicle is operational;
said vehicle power being connected to said second window regulator when said vehicle is started and adapted to lower said window glass shrouds if said window glass shrouds are in a deployed state when said vehicle is started from a non-operational state to an operational state.

2) The vehicle window glass protection system of claim 1, further comprising:
a remote switch for electrically connecting said second window regulator and vehicle power when said vehicle is in a non-operational state.

3) The vehicle window glass protection system of claim 1, wherein:
said first window regulator and said second window regulator comprise a regulator motor and an elongated rail connected to said vehicle door within its interior volume;
a movable hub along said rail positionable between a first and second pulley;
said regulator motor adapted to turn a spool connected to a cable;
said cable connecting over said first and second pulley to opposite sides of said moveable hub.
